(19) United States
(12) Patent Application Publication
(10) Pub. No.: US 2025/0385086 A1
(43) Pub. Date: Dec. 18, 2025

(54) ION FOCUSING AT ATMOSPHERIC PRESSURE USING A VOLTAGE GRADIENT

(71) Applicant: Battelle Memorial Institute, Richland, WA (US)

(72) Inventors: Robert G. Ewing, Kennewick, WA (US); Elizabeth H. Denis, Seattle, WA (US); Garret L. Hart, West Richland, WA (US); Megan K. Nims, Richland, WA (US); Shannon E. Schrader, Richland, WA (US)

(73) Assignee: Battelle Memorial Institute, Richland, WA (US)

(21) Appl. No.: 19/238,083

(22) Filed: Jun. 13, 2025

Related U.S. Application Data
(60) Provisional application No. 63/660,021, filed on Jun. 14, 2024.

(51) Int. Cl. H01J 49/06; G01N 27/622; H01J 49/02

(52) U.S. Cl. CPC H01J 49/068; G01N 27/622; H01J 49/025

(57) ABSTRACT

An apparatus includes an atmospheric flow tube including field-free input and main regions, and an output region, wherein the atmospheric flow tube is configured to direct ions along the atmospheric flow tube with a gas flow, an ion detector situated to receive ions from the output region through an input orifice of the ion detector, and an electrode situated in relation to the output region and input orifice to produce a voltage gradient in the output region that converges the ions propagating along the output region to increase an ion flux into the input orifice. Related methods are disclosed.

### CROSS REFERENCE TO RELATED APPLICATION

This application claims the benefit of U.S. Provisional Patent No. 63/660,021, filed Jun. 14, 2024, which is incorporated by reference herein.

### ACKNOWLEDGMENT OF GOVERNMENT SUPPORT

This invention was made with government support under DE-AC0576RL01830 awarded by the U.S. Department of Energy. The government has certain rights in the invention.

### FIELD

The field is ion detection.

### BACKGROUND

Atmospheric flow tube mass spectrometry (AFT-MS) is an analytical technique that can be used to study the chemical composition of aerosolized samples. Systems typically include a flow tube (most often cylindrical) in which an aerosolized sample is introduced. The gas phase sample is mixed with a reactant ion in the flow tube and the sample and reactant can interact as they flow down the tube to ionize the sample, at or near atmospheric pressure. The ionized sample can then be received and detected by an ion detector like a mass spectrometer. AFT-MS can be a powerful tool to rapidly detect sample characteristics at atmospheric pressure, having numerous real-world applications like airport screening, environmental sampling, and pollution monitoring. However, detection sensitivity continues to be an important parameter, as samples can include only trace amounts of a substance of interest. Therefore, a need remains for systems and methods using atmospheric flow tubes that have improved sensitivity.

### SUMMARY

According to an aspect of the disclosed technology, apparatus include an atmospheric flow tube including field-free input and main regions, and an output region, wherein the atmospheric flow tube is configured to direct ions along the atmospheric flow tube with a gas flow, an ion detector situated to receive ions from the output region through an input orifice of the ion detector, and an electrode situated in relation to the output region and input orifice to produce a voltage gradient in the output region that converges the ions propagating along the output region to increase an ion flux into the input orifice. In some examples, the electrode comprises a transmissive screen. In some examples, the electrode is spaced apart from an outlet of the atmospheric flow tube and the input orifice. In some examples, the electrode is attached to an outlet of the atmospheric flow tube. In some examples, the electrode is integral with a body of the atmospheric flow tube at or near an outlet of the atmospheric flow tube. In some examples, the electrode comprises a surface surrounding or defining the input orifice. In some examples, the surface extends laterally perpendicular to an input axis of the input orifice. In some examples, the atmospheric flow tube includes one or more tube electrodes coupled to a body of the atmospheric flow tube and that are configured to provide the field-free input and main regions. In some examples, the one or more tube electrodes comprises a cylindrical conductive layer that extends along the body. In some examples, the ion detector is a Faraday plate detector. In some examples, the ion detector is a mass spectrometer. Some examples further include a controller configured to change a voltage applied to the electrode and/or a flowrate of the gas flow, wherein the change is configured to adjust the converging of the ions propagating along the output region. Some examples further include a movement stage coupled to the electrode, orifice, and/or atmospheric flow tube, wherein the movement stage is configured to adjust a positioning of the convergence in relation to the orifice and atmospheric flow tube.

According to another aspect of the disclosed technology methods include producing a voltage gradient in an output region of an atmospheric flow tube using an electrode situated in relation to the output region and an input orifice of an ion detector, wherein the atmospheric flow tube includes electric field-free input and main regions, directing ions along the atmospheric flow tube with a gas flow, and converging the ions propagating along the output region with the voltage gradient to increase an ion flux into the input orifice. In some examples, the electrode comprises a transmissive screen. In some examples, the electrode is spaced apart from an outlet of the atmospheric flow tube and the input orifice. In some examples, the electrode is attached to an outlet of the atmospheric flow tube. In some examples, the electrode is integral with a body of the atmospheric flow tube at or near an outlet of the atmospheric flow tube. In some examples, the electrode comprises a surface surrounding or defining the input orifice. In some examples, the surface extends laterally perpendicular to an input axis of the input orifice. In some examples, the atmospheric flow tube includes one or more tube electrodes coupled to a body of the atmospheric flow tube, and further comprising providing the electric field-free input and main regions with a voltage applied to the one or more tube electrodes. In some examples, the one or more tube electrodes comprises a cylindrical conductive layer that extends along the body. In some examples, the ion detector is a Faraday plate detector. In some examples, the ion detector is a mass spectrometer. Some examples further include changing a voltage applied to the electrode and/or a flowrate of the gas flow using a controller, wherein the change is configured to adjust the converging of the ions propagating along the output region. Some examples further include adjusting a positioning of the convergence in relation to the orifice and atmospheric flow tube using a movement stage coupled to the electrode, orifice, and/or atmospheric flow tube.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a side cross-sectional schematic view of an example ion detection system that uses an atmospheric flow tube.

FIG. 2 is a side cross-sectional schematic view of an example end region.

FIG. 3 is a side cross-sectional schematic view of another example end region.

FIG. 4 is a side cross-sectional schematic view of another example end region.

FIG. 5 is a flowchart of example methods.

FIG. 6 is a side cross-sectional view of ion trajectories from a simulation.

FIGS. 7A-7C are side cross-sectional views of ion trajectories from simulations with different voltage gradients.

FIGS. 8A-8B are side cross-sectional perspective schematics of example atmospheric flow tubes (AFTs).

FIGS. 9A-9B are side cross-sectional perspective schematics of example AFTs.

FIG. 10 is a graph of ion detection performance for different voltages between a tube of an AFT and an electrode.

FIGS. 11A-11B are graphs of ion detection performance for different alignments between AFT axes and input orifices.

FIGS. 12A-12C are graphs showing variation in detection for different air flowrates.

FIGS. 13A-13B are graphs showing variation in detection for different materials.

FIGS. 14A-14B are graphs showing ion detection performance at different flowrates.

FIG. 15 is a schematic of an example system that uses a plurality of focusing arrangements to propagate ions at atmospheric pressure.

### DETAILED DESCRIPTION

Increased ion-molecule reaction time is a significant parameter for atmospheric flow tube-mass spectrometry (AFT-MS). AFT-MS has demonstrated revolutionary low detection limits enabling vapor detection (low parts-per-quadrillion levels) of explosives, drugs, and other substances. The increased sensitivity can be gained in the flow tube, with ion residence times of a few seconds providing a significant increase in the number of ion-molecule collisions compared to common mass spectrometry systems with millisecond reaction times. However, during this slower ion transit time a substantial number of ions are lost, causing an overall reduction in the total ion signal. Regardless of the ion detection system, at atmospheric pressure ion loss through diffusion continues to limit the total number of ions reaching the detector. In disclosed examples, ion manipulation at atmospheric pressure can reduce the ion loss by converging ions at the orifice to the mass spectrometer or other ion detector.

Controlling ion movement is complex and, although often demonstrated at reduced pressure (e.g., under vacuum at a few torr or below), it is a particular challenge at atmospheric pressure. Ion manipulation at atmospheric pressure is difficult due to collisions with air molecules, diffusion, and ion-ion repulsions. Prior attempts to trap ions at atmospheric pressure have achieved minimal success in improving ion signal. More recently some progress has been made with ion manipulation techniques. For example, controlled use of counterions can be used to enhance ion signals. Ion focusing at ambient pressure has been demonstrated by employing electric field modulations (nonlinear DC voltage sequences) to a stacked ring ion guide (e.g., in the drift region of an ion mobility spectrometer). The ion funnel, initially developed for focusing ions at lower pressures, also has been used with direct analysis in real time-mass spectrometry to focus ions at ambient pressure. While these ion manipulation techniques have produced limited improvements to ion signal, such enhancements typically are limited to a doubling of the ion signal. Disclosed examples leverage a unique approach to in focusing at atmospheric pressure that can produce in 5× to 10× increase in ion signal and additional increases may be achieved with further optimization.

In an AFT, the gas is at atmospheric pressure, and ions and analyte vapors move down a tube driven by gas flow. The tube is typically in the form of a cylinder and can comprise an electrically conducting metal tube that may be held at a constant potential. Within the cylinder the ions can experience an approximately field-free region along the path direction. In many examples, the region can be field-free laterally as well and such that ions in it can be subject to only the forces of gas flow, diffusion, and ion-ion charge interactions, for approximately the entire length. As will be discussed, disclosed examples can reduce ion loss at atmospheric pressure by converging ions (also referred to as focusing) from the AFT towards the detector.

In various disclosed examples, limitations associated with previous AFT approaches can be addressed by focusing or converging ions using a voltage gradient between a flow tube (which can have a region that is electric field-free) and a detector. By placing a voltage difference between the flow tube and the detector, electric field lines can be created that extend into the tube and direct the ions towards the axial center of the flow tube. A larger voltage difference results in greater focusing. In many examples, to define this voltage difference, a single, direct step-down in voltage is applied between the AFT and the device in which ions are coupled into. This focusing can reduce ion loss due to diffusion and increase the total ion signal at the detector. In experimental arrangements, ion focusing at atmospheric pressure resulted in the increase of 5 to 10 times in ion signal discussed above, though it is projected that additional improvements may be achieved through further optimization. Ion manipulation and increased ion signal at atmospheric pressure can enable enhanced sensitivity with smaller, more portable devices useful in the analysis of various items of concerns including explosives and drugs.

An AFT-MS capable of detecting low-parts-per-quadrillion levels of vapor and femtogram levels of residue would find immediate use in a host of applications, especially if a more portable AFT-MS were available. Extremely low levels of detection can be achieved by increasing an ion-molecule reaction time in the ambient ionization source from milliseconds to seconds, resulting in ˜1000× increase in reaction time and a greater efficiency of analyte ion formation. However, a consequence of increased reaction time is a decrease in the total ion density as ions diffuse and are lost from the ion flow path. One method to overcome the loss of ions (the decrease in ion density) with the increased reaction time is to increase the size of the inlet to the mass spectrometer (MS) allowing the capture of more ions. For example, an example MS has a sizeable 0.6 mm diameter inlet between the ambient ionization source and the MS, allowing the passage of more ions. However, this larger inlet requires larger pumps to maintain the necessary vacuum which results in a larger MS. Smaller mass spectrometers, which would be useful for field applications, have smaller inlets, which reduce ion throughput and thereby decease sensitivity. Ion focusing can overcome ion losses due to diffusion and can enable the development of smaller, more portable instruments, with parts-per-quadrillion detection levels of chemical threats. Disclosed examples can correspond to improved mass spectrometry and ion mobility spectrometry instruments and methods, e.g., for instruments used at airport and mass transit screening checkpoints.

In some disclosed examples, ion focusing is in an arrangement of an atmospheric flow tube (AFT) coupled to either a mass spectrometer (MS) or a Faraday plate detector. Examples generally involve ion manipulation (e.g., extraction, focusing, and confinement) at atmospheric pressure. In many examples, ions traveling through an atmospheric flow tube experience a field-free region that is subject to an applied uniform voltage and pass through the tube under the influence of air flow. In some examples, the end of the tube can be located near a conducting plate placed perpendicular to the flow tube. Placing an electric field differential between the flow tube and the plate can create electric field lines that extend into the tube and focus the ions towards a spot on the conducting plate. The focal point of the spot is determined by the axial center of the flow tube. A voltage difference between the AFT and the plate causes ion focusing. A larger voltage difference results in greater focusing.

In experiments, this focusing was demonstrated using both a mass spectrometer and a Faraday plate detector. For the mass spectrometer experiment, a hole was placed in the conducting plate that was aligned with the inlet to the mass spectrometer and arranged to extend perpendicular to the flow of the AFT. The AFT was mounted on an adjustable height table with the center of the AFT aligning with the inlet. As the voltage between the AFT and the conducting plate increased, the signal measured by MS also increased. In a different experiment, while the ion signal was monitored by the MS, the table was raised and lowered sweeping the focused ion beam across the inlet, which allowed the ion beam profile to be measured. The width of the beam decreased as the voltage difference increased. A narrower beam width demonstrates increased ion focusing. In a different experiment, a Faraday plate was mounted at the end of the AFT. Using a Faraday plate with a diameter approximately equal to that of the AFT, similar ion currents were measured at increasing voltages between the tube and the plate. Smaller faraday plates showed a much smaller ion current with no focusing, however as the voltage increased between the AFT and the Faraday plate, the signal rapidly increased, approaching the same signal observed with the larger plate. In some examples, at higher voltages, the ion beam can be focused nearly completely onto the smaller plate.

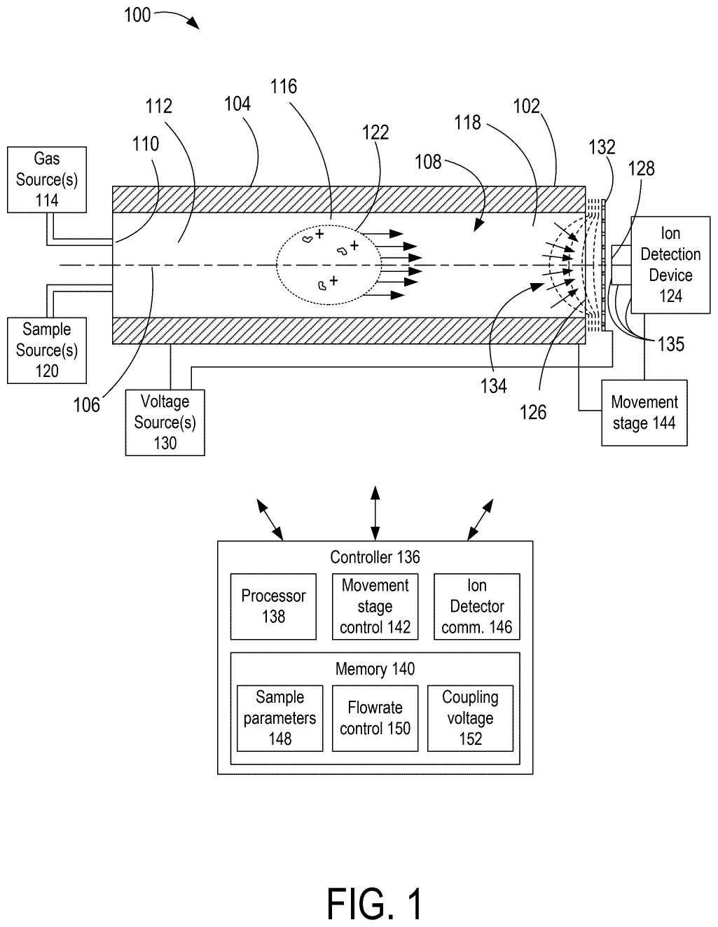

FIG. 1 is an example ion detection apparatus 100 configured to detect ions produced in an atmospheric flow tube (AFT) 102. The AFT 102 can include a tube body 104 that is typically straight, rigid, and cylindrical, though other path shapes, body characteristics, and cross-sections are possible. The tube body 104 can have a flow tube axis 106 generally defining an interior volume 108 and path for gas to flow and ion forming collisions to occur. The AFT 102 can include one or more flow tube inlets 110 at an input region 112. A gas source 114 can be coupled to the input region 112 to introduce a gas into the interior volume 108 that propagates along the interior volume 108 through a main region 116 and that can exit from an output region 118. A sample source 120 can be coupled to the input region 112 to direct a sample vapor and reactant ions into the input region 112. In many examples, the sample vapor and reactant ions can be directed into the input region 112 from different inputs (e.g., end inputs, side inputs, etc.). As the sample vapor and reactant ions propagate along the interior volume 108, they interact to form analyte ions 122 that also propagate as the gas flows along the interior volume 108.

The ion detection apparatus 100 can further include an ion detection device 124 (which also may be referred to as an ion detector) coupled to an outlet 126 of the AFT 102. The analyte ions 122 can exit the outlet 126 and be directed into an input orifice 128 of the ion detection device 124. In some examples, the ion detection device 124 can be a mass spectrometer. In further examples, the ion detection device 124 can be a Faraday plate detector. It will be appreciated that other ion detection devices may be used as well, such as ion mobility spectrometers, ion traps, etc. Gas that is not coupled into the input orifice 128 can exit the outlet 126 and leak out the sides and be directed elsewhere, such as to an exhaust and/or a sampling pump for recirculation.

A voltage source 130 can be coupled to the AFT 102, e.g., to the tube body 104 or a portion or portions of the tube body 104. In representative examples, the voltage source 130 can apply a common voltage to across the tube body 104 to produce a field-free volume in a substantial portion of the interior volume 108, throughout the input and main regions 112, 116 and through some or most of the output region 118. For example, the tube body 104 can be metallic or include a metal layer, forming an electrode that extends between the length of the tube body 104. In many examples, the absence of an electric field remains static over time.

The voltage source 130 (or a separate voltage source) can also be coupled to an electrode 132 that is situated in relation to the output region 118 and the input orifice 128 of the ion detection device 124 to produce a voltage gradient 134 in the output region 118, depicted with dashed equipotential lines. The electrode 132 receives a voltage different from the voltage applied to the tube body 104 to produce the voltage gradient. As can be seen from the convergent arrows, the voltage gradient 134 extends into the output region 118 and causes the analyte ions 122 to converge as the ions propagate along the output region 118. This allows analyte ions 122 that would miss the input orifice 128 to instead converge and become focused into the input orifice 128 and into the ion detection device 124, thereby increasing the ion density and ion flux into the ion detection device 124. The voltage gradient 134 can be selected based on various factors, such as characteristics of the AFT 102 like interior region cross-section (e.g., diameter), characteristics of the ion detection device 124 like input orifice cross-section (e.g., diameter), characteristics of the coupling between the AFT 102 and ion detection device 124 like spatial separation, coupling of exit gas, etc., flowrate of the gas, and characteristics of the analyte ions 122 to be detected (mobility, m/z, etc.), by way of example. Examples for the voltage gradient 134 can be in the range of 1-10 V, 10-100 V, 100-200 V, 200-400 V, 400-1000 V, etc.

As shown, the electrode 132 is a transmissive screen that is spaced apart from the outlet 126, but other shapes and configurations are possible. For example, some examples of the electrode 132 can be attached to or formed into the tube body 104. In further examples, the electrode 132 can be part of (e.g., integral with) or attached to the ion detection device 124. By way of example, one or more conductive surfaces 135 that surround or define the input orifice 128 can correspond to the electrode 132. In some examples of the electrode 132 that is part of (e.g., integral with) or attached to the ion detection device 124, the conductive surfaces 135 can be made to extend laterally at or near the plane of the input orifice 128, e.g., perpendicularly to an axis of the input orifice 128 (and thereby perpendicular to the axis 106). In general, the electrode 132 can be made to extend to be coextensive with or larger than the area of the outlet 126. The electrode 132 and extension direction is generally planar in most examples. In examples where the electrode 132 is attached to or formed into an end of the tube body 104, the electrode 132 can be separated from a main tube electrode defining the field-free region of the AFT 102 with a standoff or through attachment to an AFT support or body member. Some examples can include an insulative material to space the electrode 132 from other electrically conductive components.

The ion detection apparatus 100 can include a controller 136 that is coupled to various components of the ion detection apparatus 100 to control operation and ion detection. The controller 136 typically includes one or more processors 138 and memory 140 configured with processor executable instructions to carry out various tasks and functions of the ion detection apparatus 100. For example, the controller 136 can include movement stage automated and/or manual movement stage control 142 that can control a movement stage 144 coupled to the AFT 102, electrode 132, and/or ion detection device 124. The movement stage 144 can be used to adjust a positioning of the convergence provided by the voltage gradient 134 in relation to the input orifice 128 and AFT 102. In some automated examples, positional adjustment can be performed based on a series of analyte detections, e.g., by detecting analyte ions at different positions after movement in various directions (e.g., along the flow tube axis 106 and/or laterally in with respect to the flow tube axis 106) and selecting a suitable position or positions based on detection maxima or threshold criteria. In many examples, the outlet 126 and input orifice 128 are both circular, allowing an alignment between the flow tube axis 106 and a center axis of the input orifice 128 to correspond to a suitable x-y alignment.

In some examples, the controller 136 can be in communication 146 with the ion detection device 124 (e.g., wired or wirelessly) to send and receive detection signals or to control timing for detections. In some of such examples, the communication 146 can be used to control or coordinate the voltage gradient 134 through application of a voltage to the surface surrounding or defining the input orifice 128 (which may be provided by the voltage source 130 or another voltage source, such as one that is part of the ion detection device 124). The memory 140 can store sample parameters 148 such as user inputs, detections, or parameters related to operation that can be adjusted like gas flowrate 150, or the voltage 152 applied to the electrode 132 to cause the ions 122 to converge and couple into the input orifice 128, by way of example. Adjustable parameters can be varied, e.g., based on the type of samples to be detected, characteristics of the AFT 102 or ion detection device 124, etc.

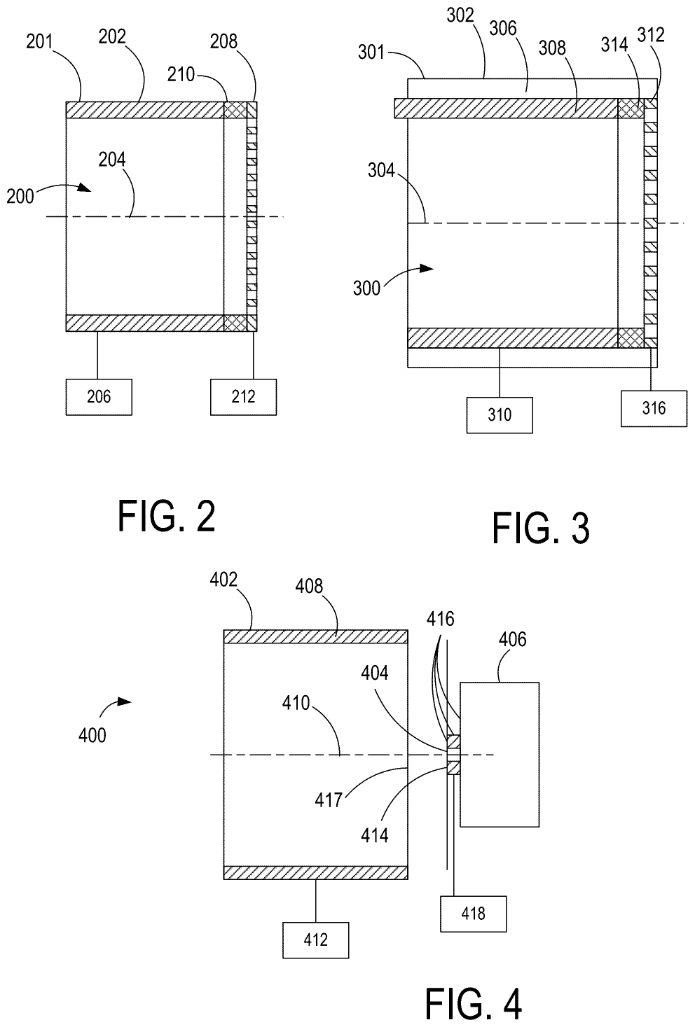

FIG. 2 is an example end region 200 of an AFT 201, such as AFT 102. The AFT 201 includes a portion of a tube body 202 extending along a tube axis 204. The tube body 202 can be electrically conductive and coupled to a voltage source 206 to receive a voltage that provides a field-free region in an interior region of the tube body 202, including in a portion of the end region 200. A separate electrode 208 (e.g., corresponding to an example of electrode 132) can be attached at an end of the end region 200, with an interposed insulating spacer 210 providing electrical separation. The separate electrode 208 can be coupled to voltage source 212 to apply a different voltage as the voltage source 206. The voltage gradient that is produced can be configured to converge ions propagating through the end region 200 at atmospheric pressure. As shown in cross-section, the separate electrode 132 has a grid configuration. In many examples, grids and screens can have equally spaced perpendicularly arranged members, but different spacings are possible, including irregular, annular, etc. In some examples, the separate electrode 208 can be a transmissive screen electrode. In further examples, a centrally arranged orifice can be defined by an electrode structure that extends laterally (e.g., perpendicularly) with respect to the tube axis 204 and past a diameter of the end region 200. In such examples, the centrally arranged orifice can correspond to a diameter of a subsequent input orifice of an ion detector or to other larger values.

FIG. 3 is an example of another end region 300 of an AFT 301, such as AFT 102. The AFT 301 includes a portion of a tube body 302 extending along a tube axis 304. The tube body 302 can include a cylindrical support 306 that can extend along the end region 300. A tube electrode 308, e.g., in the form of a cylindrical conductive layer, can be coupled to the support 306 and can be coupled to a voltage source 310 to receive a voltage that provides a field-free region in an interior region of the tube body 302, including in a portion of the end region 300. A separate electrode 312 (e.g., corresponding to an example of electrode 132) can be attached to the support 306 at an end of the end region 300. An interposed insulating spacer 314 can provide electrical separation from the tube electrode 308 (or no spacer in some examples). The separate electrode 312 can be coupled to voltage source 316 to apply a different voltage as the voltage source 310. The voltage gradient that is produced in the end region 300 can be configured to cause the ions to converge as they are propagating through the end region 300 at atmospheric pressure.

FIG. 4 is an example of an end region 400 of an AFT 402 coupled to an input orifice 404 of a mass spectrometer 406 (e.g., such as corresponding to AFT 102, input orifice 128, and ion detection device 124). The AFT 402 includes a portion of a tube body 408 extending along a tube axis 410. The orifice 404 is spaced apart from an end of the AFT 402 along the tube axis 410 to receive ions for detection. (In some examples of the end region 400 as well as other examples disclosed herein, the orifice can be inserted a small extent inside the interior of the end region). A voltage source 412 can be coupled to an electrode of the tube body 408 to provide an electric field-free extent in an interior region of the AFT 402, including in a portion of the end region 400. A separate electrode 414 (e.g., corresponding to an example of electrode 132) can correspond to a surface or surfaces 416 of the mass spectrometer 406, e.g., surfaces surrounding or defining the orifice 404. In some examples, the surfaces 416 can extend laterally from the input orifice 404 with respect to the input direction into the input orifice 404, e.g., rather than being defined by an extent of a protruding input of the mass spectrometer 406 or other detection device. In general, the lateral extent of the surfaces 416 can exceed a diameter or cross-section of an outlet 417 of the AFT 402. The separate electrode 414 can be coupled to voltage source 418 to apply a different voltage as the voltage source 412. The voltage gradient that is produced in the end region 400 can be configured to cause the ions to converge as they are propagating through the end region 400 at atmospheric pressure.

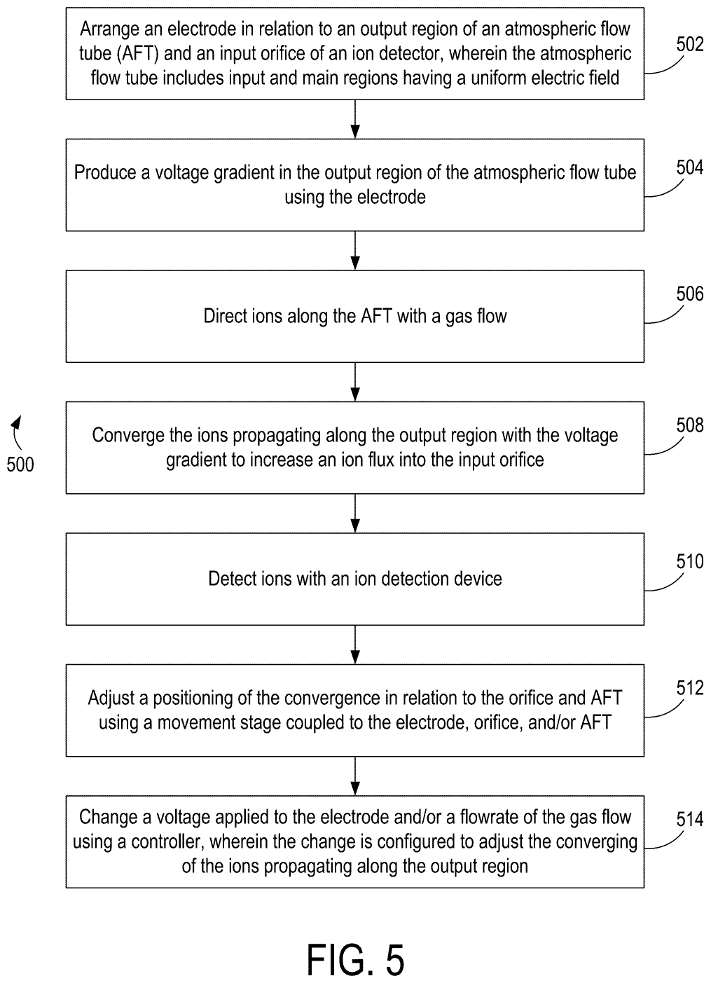

FIG. 5 is a flowchart of example methods 500 of performing ion detections. In some examples, at 502, an electrode is arranged in relation to an output region of an atmospheric flow tube (AFT) and an input orifice of an ion detector, wherein the atmospheric flow tube includes input and main regions being electric field-free. In many examples, this is not necessary as a system can be pre-arranged or calibrated, e.g., before operation or during manufacture. At 504, a voltage gradient can be produced in the output region of the AFT using the electrode, which can be used to convergence of analyte ions propagating through the AFT. At 506, ions can be directed along the AFT with a gas flow. At 508, the ions propagating along the output region can be caused to converge with the voltage gradient. This can increase ion flux (or ion density) into the input orifice of the ion detector. At 510, ions can be detected with the ion detection device.

In some examples, at 512, a positioning of the convergence in relation to the orifice and AFT can be adjusted using a movement stage coupled to the electrode, orifice, and/or AFT. At 514, a voltage applied to the electrode and/or a flowrate of the gas flow can be changed using a controller. This change can be configured to adjust the converging of the ions propagating along the output region, e.g., to increase an ion detection rate.

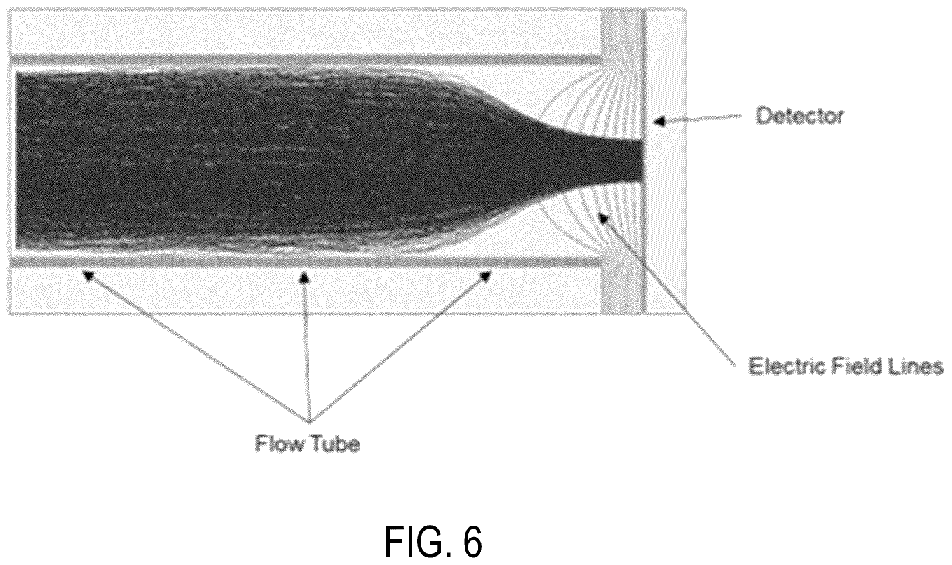

FIG. 6 shows simulated ion trajectories using SIMION® with 5000 V applied to a flow tube and 4000 V on a detector. Airflow from left to right moves the ions down the tube (set of traces forming a bottle shape) toward the detector. The voltage gradient between the flow tube and the detector causes an electric field gradient. The ions are focused toward the axial center based on the electric field lines.

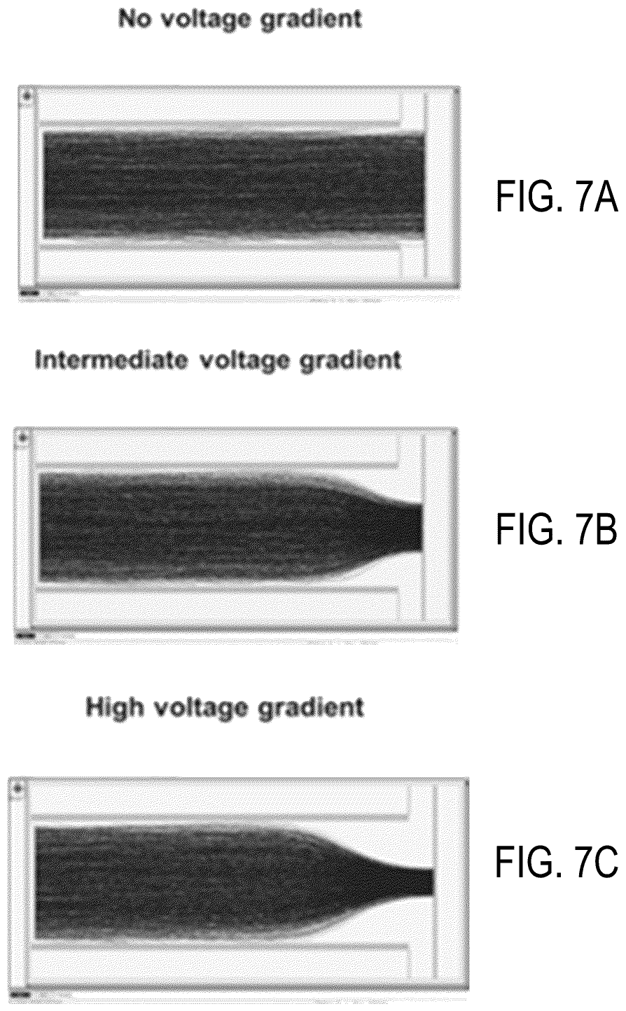

FIGS. 7A-7C show ion trajectory simulations using SIMION® where airflow from left to right moves the ions down the tube toward the detector. By increasing the voltage gradient between the flow tube and the detector, a focusing of ions on the detector can be seen to increase.

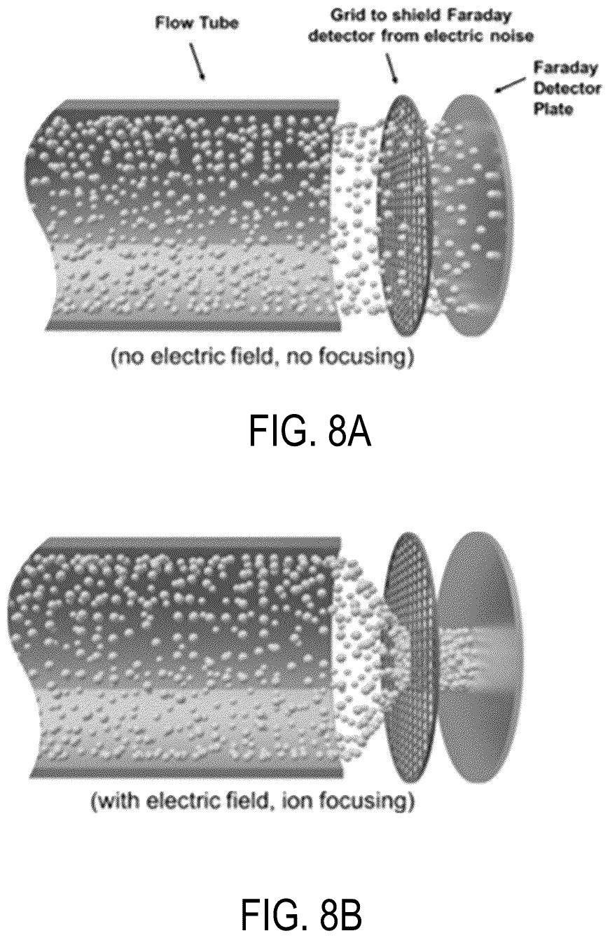

FIGS. 8A-8B show an example AFT ion detection system that uses a Faraday detector plate and a transmissive grid that shields the Faraday detector plate from electrical noise. In experiments, ion signal (intensity) was measured with a large Faraday plate detector. In FIG. 8A, with no voltage gradient, all ions move down the tube with all ions reaching the detector plate. In FIG. 8B, with a voltage gradient between the AFT and the grid (also known as a screen), ion focusing is achieved; however, all ions still reach the detector plate resulting in the same ion signal.

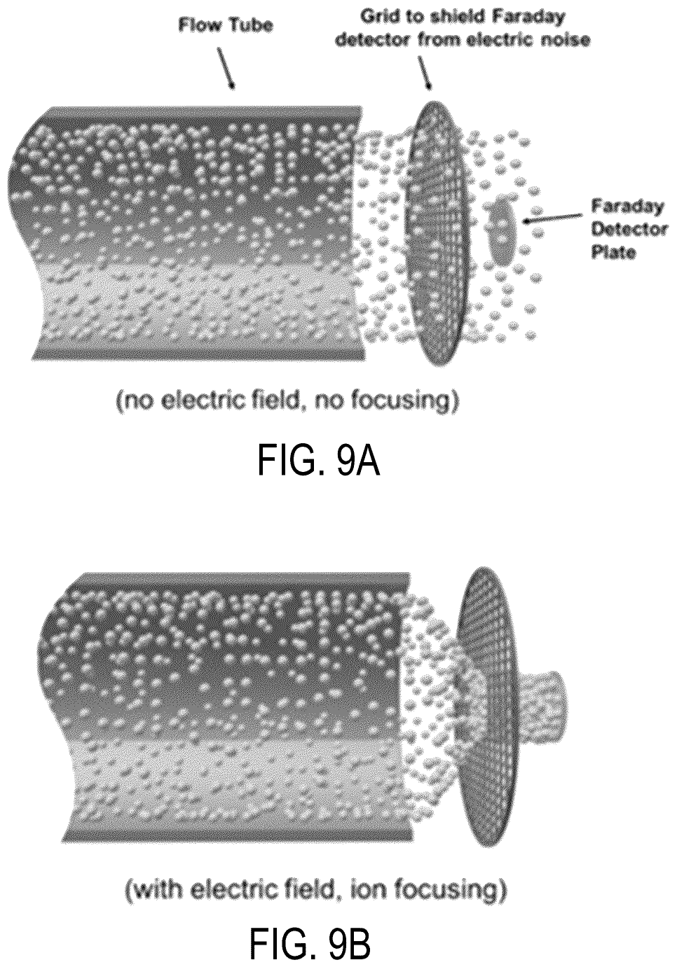

FIG. 9A-9B show another example AFT ion detection system similar to that in FIGS. 8A-8B except that the detection aperture of the Faraday detector plate is significantly smaller than the exit aperture of the flow tube exit. Ion signal (intensity) was measured and with no voltage gradient, as depicted in FIG. 9A, no focusing is achieved. Because of this, only a fraction of ions is collected on the small plate. Thus, the measured signal can correlate to the ratio of the size of the small plate to the large plate. As shown in FIG. 9B, with a voltage gradient between the AFT and the grid, ion focusing is achieved. Consequently, more ions are collected on the smaller plate, up until a maximum ion signal is achieved.

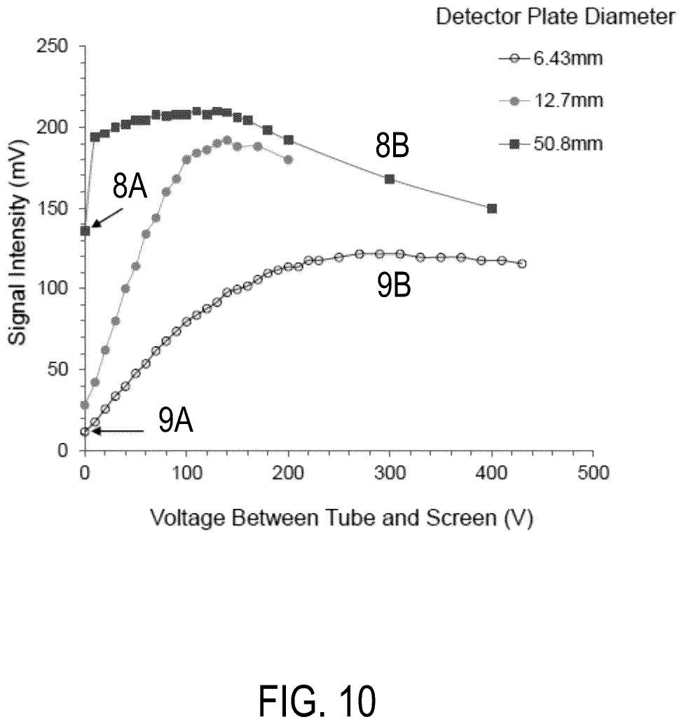

FIG. 10 is a graph showing performance characteristics for the different systems shown in FIGS. 8A-9B. With the large (50.8 mm) detector plate of the same diameter as the AFT, the signal can be invariant across voltage gradients 8A to 8B (corresponding to the specific gradients shown in FIGS. 8A, 8B, respectively). The data (top trace) shows an initial increase in signal with a corresponding increase in electric field of about 20 V between the AFT and the screen (grid). This is likely due to the electric field helping to capture ions at the rim of the detector plate that otherwise would be pushed away as a result of the airflow and not reach the detector. The slight decrease at higher voltage gradients may be due to loss of some ions on the screen. The smaller detector plates only capture a fraction of the ion signal at zero voltage gradient 9A (corresponding to the gradient shown in FIG. 9A). This is due to the reduced area of the detector surface. With ion focusing at higher voltage gradients, the signal on the on the small detector plate proportionally increases, such as with gradient 9B (corresponding to the gradient shown in FIG. 9B), relative to the large detector plate. Performance for an intermediately sized detector plate is also shown.

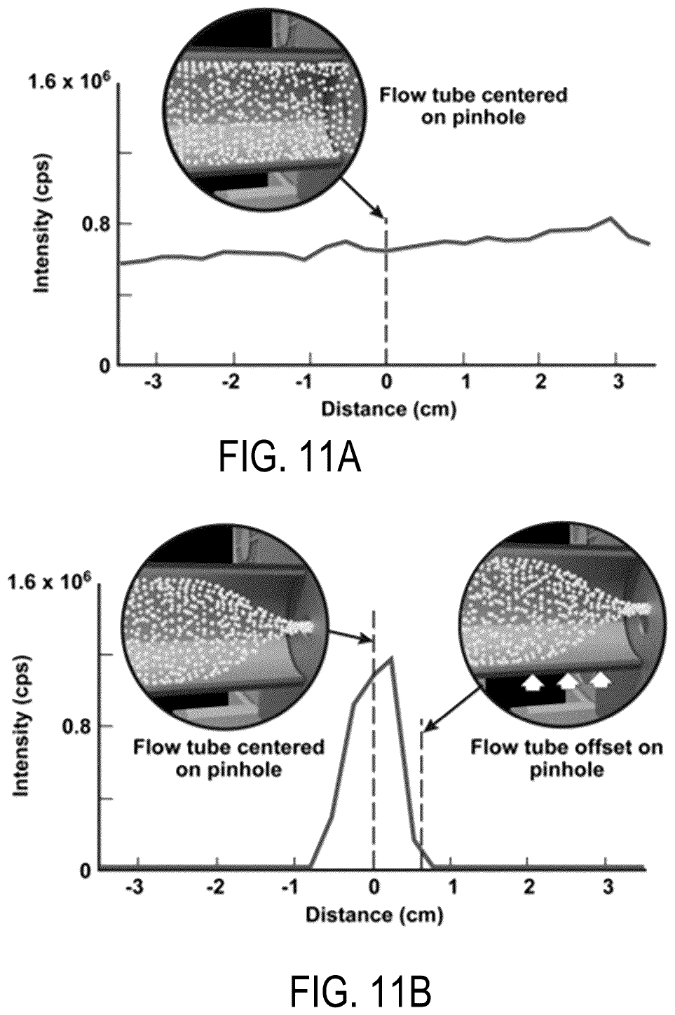

FIG. 11A is a graph of ion density performance for ions traveling from an atmospheric flow tube into a mass spectrometer using no electric field or focusing. The measurements correspond to ion signal (intensity) as the tube is moved across the inlet of the mass spectrometer. The signal remains mostly uniform across the diameter of the tube. FIG. 11B is a similar graph of ion density measurements with a mass spectrometer, but with an applied electric field and therefore ion focusing. The ion signal (intensity) was measured as the tube is moved across the inlet of the mass spectrometer. Advantageously, with an electric field, ions are focused to the center of the tube.

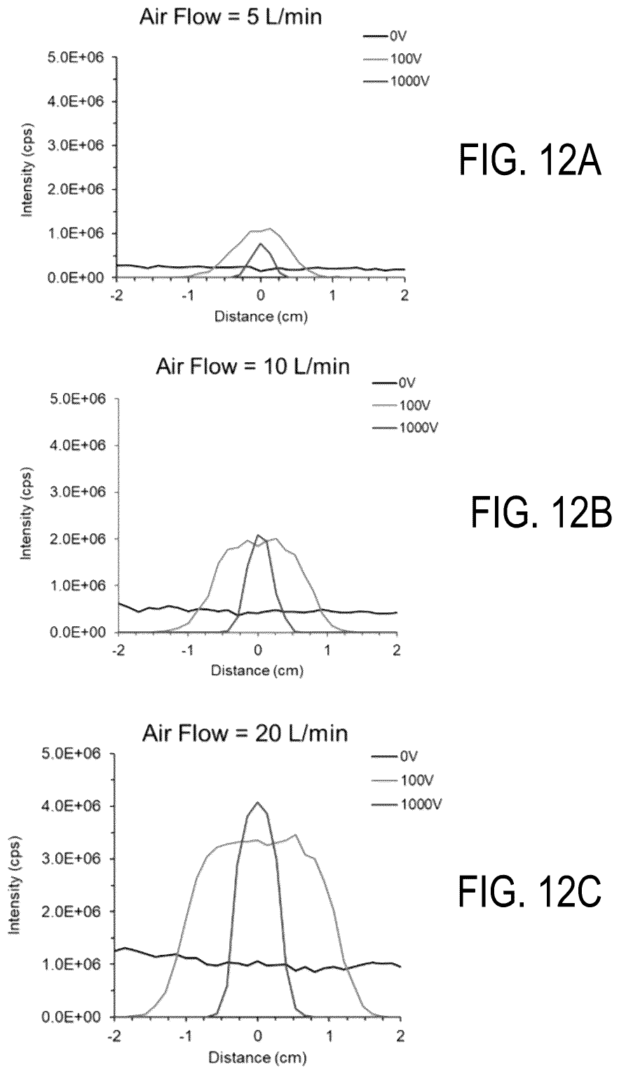

FIGS. 12A-12C are graphs of ion density measurements taken with a mass spectrometer using a 2-inch OD AFT. The graphs show measured ion signal (intensity) while moving the flow tube across the inlet (and at different voltage gradients). The tube was moved from −2 cm to +2 cm from center of the inlet. Data was collected at three different air flow rates down the flow tube: 5 L/min (FIG. 12A), 10 L/min (FIG. 12B), and 20 L/min (FIG. 12C). At higher flow rates, more ions reach the end of the tube. Larger voltage gradients result in more focusing with intensity generally increasing; the specific trend is flow dependent. In disclosed examples, focusing can be configured and optimized based on voltage gradient and flow velocity. A greater than 4× increase in ion signal with focusing was observed in comparison to ion signal with no focusing.

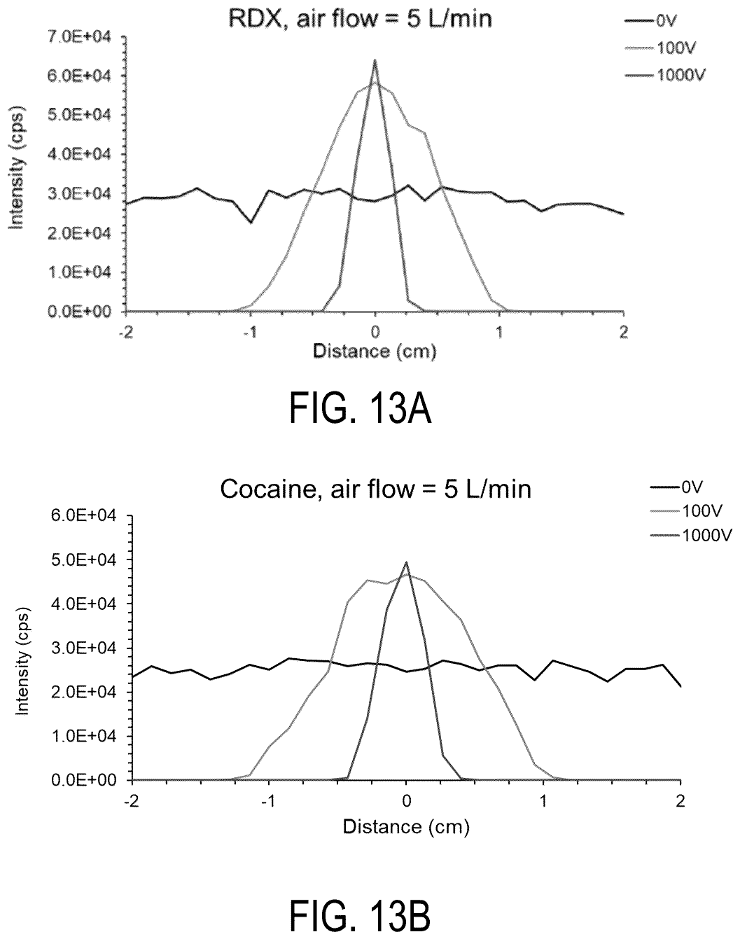

FIGS. 13A-13B are graphs showing examples of analyte detection and response. FIG. 13A shows RDX response. RDX is an explosive that is ionized through forming an RDX-nitrate adduct (m/z 284), which is a negative ion. FIG. 13B shows cocaine response. Cocaine is a drug that is ionized by proton transfer forming protonated cocaine (m/z 304), which is a positive ion. Both graphs depict ion density measurements with a mass spectrometer and a 2-inch OD AFT. The ion signal (intensity) was measured while moving the flow tube across the inlet (and at different voltage gradients). The tube was moved from −2 cm to +2 cm from center of the inlet.

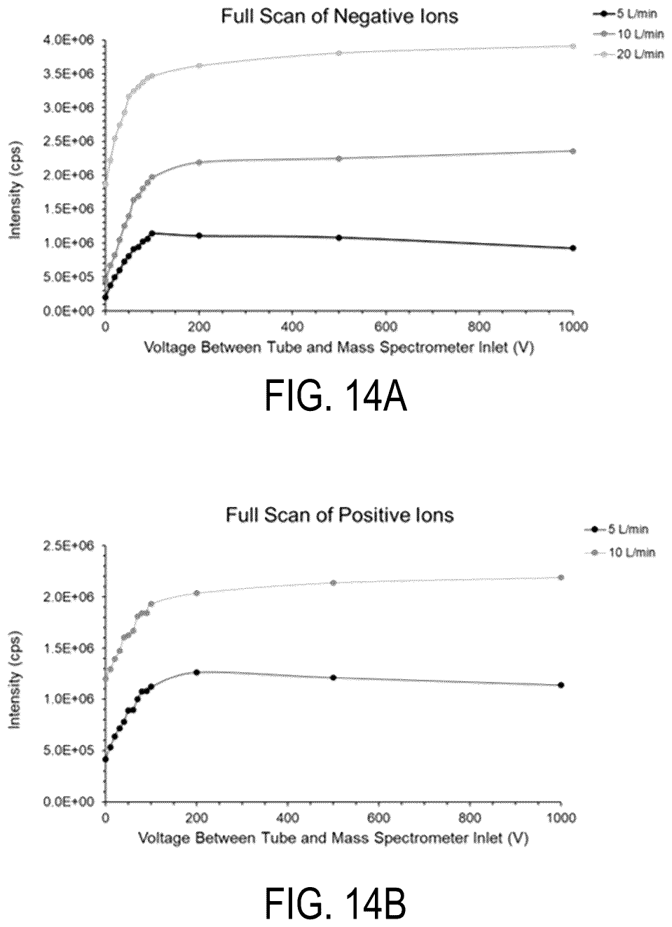

FIG. 14A shows a graph of ion density measurements of negative ions with a mass spectrometer at three different air flow rates. The total ion signal (intensity) was measured with the tube centered on the inlet and voltage was varied. At all three flow rates, most of the increase in signal was observed between 0 V and 100 V field gradient. Signal increases of greater than 5× can be observed at the lower air flow rate. FIG. 14B show a graph of ion density measurements of positive ions with a mass spectrometer at two different air flow rates. The total ion signal (intensity) was measured with the tube centered on the inlet and voltage was varied. At all three flow rates, most of the increase in signal was observed between 0 V and 100 V field gradient. Signal increases of greater than 3× can be observed at the lower air flow rate.

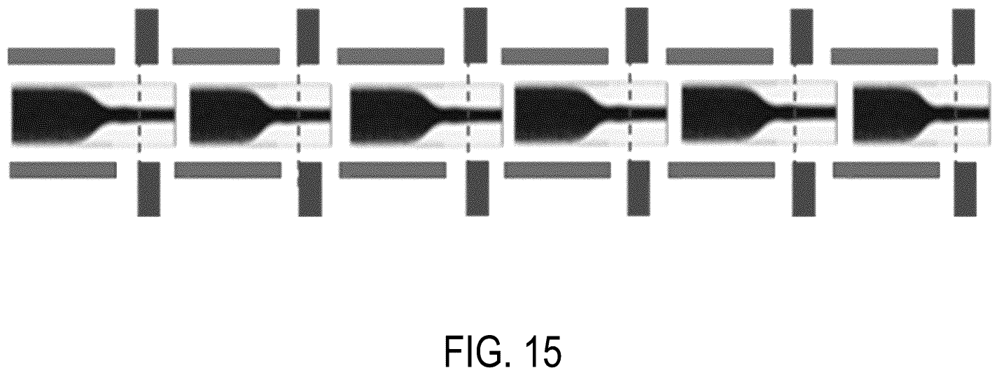

FIG. 15 is an example system that includes a series arrangement of a plurality of small atmospheric flow tubes, each followed by a screen or plate. By coupling multiple AFT segments in series as shown, a system can allow for continuously focusing ions between each segment. The ions will begin to diffuse towards the walls in the first part of the following segment, but then become refocused. The screen between each segment can reset the field lines for the next segment. The net result can be to increase the overall ion density that reaches the end of the series of tubes. For a single AFT of the same length, the ions would be lost to the walls continuously as they flow down the tube.

### General Considerations

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Having described and illustrated the principles of the disclosed technology with reference to the illustrated embodiments, it will be recognized that the illustrated embodiments can be modified in arrangement and detail without departing from such principles. For instance, elements of the illustrated examples can be implemented in software and/or in hardware and vice-versa. Also, the technologies from any example can be combined with the technologies described in any one or more of the other examples. It will be appreciated that procedures and functions such as those described with reference to the illustrated examples can be implemented in a single hardware or software module, or separate modules can be provided. The particular arrangements above are provided for convenient illustration, and other arrangements can be used.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope of the appended claims.

We claim:

1. An apparatus, comprising:
an atmospheric flow tube including field-free input and main regions, and an output region, wherein the atmospheric flow tube is configured to direct ions along the atmospheric flow tube with a gas flow;
an ion detector situated to receive ions from the output region through an input orifice of the ion detector; and
an electrode situated in relation to the output region and input orifice to produce a voltage gradient in the output region that converges the ions propagating along the output region to increase an ion flux into the input orifice.

2. The apparatus of claim 1, wherein the electrode comprises a transmissive screen.

3. The apparatus of claim 1, wherein the electrode is spaced apart from an outlet of the atmospheric flow tube and the input orifice.

4. The apparatus of claim 1, wherein the electrode is attached to an outlet of the atmospheric flow tube.

5. The apparatus of claim 1, wherein the electrode is integral with a body of the atmospheric flow tube at or near an outlet of the atmospheric flow tube.

6. The apparatus of claim 1, wherein the electrode comprises a surface surrounding or defining the input orifice.

7. The apparatus of claim 6, wherein the surface extends laterally perpendicular to an input axis of the input orifice.

8. The apparatus of claim 1, wherein the atmospheric flow tube includes one or more tube electrodes coupled to a body of the atmospheric flow tube and that are configured to provide the field-free input and main regions.

9. The apparatus of claim 8, wherein the one or more tube electrodes comprises a cylindrical conductive layer that extends along the body.

10. The apparatus of claim 1, wherein the ion detector is a Faraday plate detector.

11. The apparatus of claim 1, wherein the ion detector is a mass spectrometer.

12. The apparatus of claim 1, further comprising a controller configured to change a voltage applied to the electrode and/or a flowrate of the gas flow, wherein the change is configured to adjust the converging of the ions propagating along the output region.

13. The apparatus of claim 1, further comprising a movement stage coupled to the electrode, orifice, and/or atmospheric flow tube, wherein the movement stage is configured to adjust a positioning of the convergence in relation to the orifice and atmospheric flow tube.

14. A method, comprising:
producing a voltage gradient in an output region of an atmospheric flow tube using an electrode situated in relation to the output region and an input orifice of an ion detector, wherein the atmospheric flow tube includes electric field-free input and main regions;
directing ions along the atmospheric flow tube with a gas flow; and
converging the ions propagating along the output region with the voltage gradient to increase an ion flux into the input orifice.

15. The method of claim 14, wherein the electrode comprises a transmissive screen.

16. The method of claim 14, wherein the electrode is spaced apart from an outlet of the atmospheric flow tube and the input orifice.

17. The method of claim 14, wherein the electrode is attached to an outlet of the atmospheric flow tube.

18. The method of claim 14, wherein the electrode is integral with a body of the atmospheric flow tube at or near an outlet of the atmospheric flow tube.

19. The method of claim 14, wherein the electrode comprises a surface surrounding or defining the input orifice.

20. The method of claim 19, wherein the surface extends laterally perpendicular to an input axis of the input orifice.

21. The method of claim 14, wherein the atmospheric flow tube includes one or more tube electrodes coupled to a body of the atmospheric flow tube, and further comprising providing the electric field-free input and main regions with a voltage applied to the one or more tube electrodes.

22. The method of claim 21, wherein the one or more tube electrodes comprises a cylindrical conductive layer that extends along the body.

23. The method of claim 14, wherein the ion detector is a Faraday plate detector.

24. The method of claim 14, wherein the ion detector is a mass spectrometer.

25. The method of claim 14, further comprising changing a voltage applied to the electrode and/or a flowrate of the gas flow using a controller, wherein the change is configured to adjust the converging of the ions propagating along the output region.

26. The method of claim 14, further comprising adjusting a positioning of the convergence in relation to the input orifice and atmospheric flow tube using a movement stage coupled to the electrode, orifice, and/or atmospheric flow tube.
